(19) United States
(12) Patent Application Publication
(10) Pub. No.: US 2014/0363621 A1
(43) Pub. Date: Dec. 11, 2014

(54) Maintenance Free Decking and Fence and Installation Tool

(71) Applicant: Thang Ngo, Louisville, KY (US)

(72) Inventor: Thang Ngo, Louisville, KY (US)

(21) Appl. No.: 14/120,649

(22) Filed: Jun. 11, 2014

Related U.S. Application Data
(60) Provisional application No. 61/956,557, filed on Jun. 11, 2013.

(51) Int. Cl. E04B 1/66; B27B 9/02; E04C 2/20

(52) U.S. Cl. CPC E04B 1/66; E04C 2/20; B27B 9/02
USPC 428/119; 52/835; 52/309.1; 30/388

(57) ABSTRACT

A cap cover for boards made from a polymer or a wood/polymer composite. Caps having a top surface and lips extending downward from the leading edge forming a generally U-shaped lip. to be installed over the trimmed deck board have downwardly extending leading edges forming a generally U-shaped cap for installation over the top surface and both side surfaces of the deck boards. The system includes a board trimming and shaping rotary saw tool. The protective board caps are fastened to the deck boards in one of three ways. The protective caps may include means of attachment such as laterally extending barbs or teeth which snap by the bottom lateral edges of the trimmed deck boards and catch on the edges. The caps may also be used to cover fencing boards or any other wood member exposed to sun, rain, or snow to protect the wood from rotting.

### CROSS REFERENCE TO RELATED APPLICATIONS

This application claims priority to U.S. Provisional Application Ser. No. 61/956,557 filed on Jun. 11, 2013 which is incorporated herein in its entirety.

### TECHNICAL FIELD

The present invention relates to a system for applying a protective cap to the top and sides of deck boards to shield the boards from weather and traffic.

### BACKGROUND OF THE INVENTION

Decks and porches are a common addition to houses, pools and patios and are especially prevalent because of the availability of inexpensive treated lumber. Lumber treating processes are even more improved over the years. However, even with chemical preservatives, years of sunshine, rain, snow and normal use will cause treated deck boards to look weakened, cracked and discolored. Moreover the chemicals and preservatives utilized in treatment of the boards are often toxic or include environment contaminants.

Composite lumber is a relatively recent entry into the field of deck boards. Composite boards are made from a mixture of wood fibers or particles, plastic fibers or particles, and a binder to hold the mixture together formed under high pressure. Composite boards can be made from virgin plastic and/or rubber materials and or recycled plastic, rubber, or rubber and plastic, or a composite with plastic or rubber and wood materials or can be up to 100% recycled materials and can be made to be more than twice as dense and strong as wood. A major advantage achieved with the use of composite boards is that very little or no maintenance is necessary. No sealing, painting, or refinishing is required.

Conventional composite decking is often made from (low-density or high-density) polyvinyl chloride or polypropylene, virgin or recycled thermoplastics including HDPE (high-density polyethylene), LDPE (low-density polyethylene), ABS (acrylonitrile butadiene styrene), PS (polystyrene), polyvinylchloride, or PLA (polylactic acid or polylactide) added to wood particles, a binder, and other additives that stabilize the plastic and protect the deck from damaging UV rays. The most common method of production is to extrude the material into the desired shape, though injection molding is also used. Additives such as colorants, coupling agents, UV stabilizers, blowing agents, foaming agents, and lubricants help tailor the end product to the specific application. Extruded composite boards are formed into both solid and hollow profiles. Composite boards do not absorb or give off moisture, so they don't shrink or swell like wood. As a result, composite decking does not crack, warp or separate due to varying weather cycles. Composite decking resists insects, does not need water repellant or stain and will perform well in extreme weather conditions for decades.

A more recently introduced composite decking includes a different formulation on the exterior surface of the top and sides of the board which is both protective and more attractive. This outside layer is generally 0.010 to 0.050 inch thick and comes in a variety of colors.

In some manufacturing facilities, the wood particles and selected synthetics are combined and processed in a pelletizing extruder, which produces pellets of the new material. The pellets are then re-melted and formed into the final shape. Other manufacturers complete the finished part in a single step of mixing and extrusion.

The main disadvantage with composite boards is the high initial cost. However, a savings is realized in the long run because a composite board deck will outlast a wooden deck and does not need to be painted and sealed as wood does.

### SUMMARY OF THE INVENTION

In accordance with the present invention, there is provided a synthetic board cap comprising, consisting of, or consisting essentially of a U-shaped synthetic cap selected from the rubber, plastic, wood materials set forth heretofore, or combinations thereof. Moreover, the boards may have a coextruded material wherein the surface is smooth and the cross-sectional view shows a granular appearance or cellular structure filled with voids or porous material with air spaces forming a matrix.

The caps may also comprise virgin plastic and/or rubber materials and or recycled plastic, rubber, or rubber and plastic. The caps are composed of Low-density or high-density polyvinyl chloride or polypropylene, virgin or recycled thermoplastics are preferable, however, ABS (acrylonitrile butadiene styrene), PS (polystyrene), polyvinylchloride, or PLA (polylactic acid or polylactide), including HDPE (high-density polyethylene), LDPE (low-density polyethylene). A major advantage achieved with the use of composite boards is that very little or no maintenance is necessary. No sealing, painting, or refinishing is required. The cap may be of a selected size, thickness, width, length, or color.

The cap may be extruded having a top surface and connecting leading side edges forming lips extending downward therefrom a selected length forming side edges which may extend therefrom at right Angeles or The cap typically includes vertical lateral panels connecting at their top edge to a horizontal panel which may be smooth or textured. The U-shaped synthetic cap has a rectangular void formed therein between the two lateral panels sized to receive a wooden deck board trimmed to a selected width. The two lateral panels and the horizontal panel are the same length.

A system for placing protecting deck boards by covering them with caps made from a wear resistant synthetic material, polymer such as polypropylene, or a wood/polymer composite. The deck boards are trimmed to reduce the overall width of the boards which allows the U-shaped caps to be installed over the trimmed deck board with adhesive. With the U-shaped cap installed, the top surface and both side surfaces of the deck boards are covered and protected from sunlight and weather. The system includes a board trimming and shaping rotary saw tool. The protective board caps are fastened to the deck boards in one of three ways. Preferably countersunk screws with gaskets are used to fasten the caps to the boards. Alternatively, the protective caps include laterally extending barbs or teeth which snap by the bottom lateral edges of the trimmed deck boards and catch on the edges. Another means of fastening the caps to the deck boards is the application of adhesive to the top of the deck board prior to fitting the cap. Yet another method involves the use of a friction fit wherein the leading side edges of the cap are biased inward slightly permitting a slight spreading in order to be fitted over a board of a selected width.

It is an object of this invention to provide a system for extending the life of a deck or deck boards well beyond the normal lifetime of pre-treated wood decks including a protective deck board cap, a tool for preparing a deck board to receive a cap and a process for applying the cap to the deck board.

It is an object of this invention to provide a deck board cap and a process for extending the life of a deck or deck boards well beyond the normal lifetime of pre-treated wood decks while improving the appearance of the deck.

It is an object of this invention to provide a deck board cap and a process for extending the life of a deck or deck boards well beyond the normal lifetime of pre-treated wood decks without refinishing, sealing, painting or using any other treatment.

It is an object of this invention to provide a deck board cap and a process for extending the life of a deck or deck boards well beyond the normal lifetime of pre-treated wood decks which also removes the necessity of any future protection, refinishing, painting or chemical treatments.

It is an object of this invention to provide a deck board cap and a process for extending the life of a deck or deck boards well beyond the normal lifetime of pre-treated wood decks wherein a wood shaper is used to widen the gap between exiting deck boards, a U-shaped cap is applied and fastened to the top of the deck boards.

It is an object of this invention to provide a deck board cap and a process for extending the life of a deck or deck boards well beyond the normal lifetime of pre-treated wood decks which is less expensive than the cost of a complete composite deck and requires less labor than demolishing the old deck and building a new deck.

Other objects, features, and advantages of the invention will be apparent with the following detailed description taken in conjunction with the accompanying drawings showing a preferred embodiment of the invention.

### BRIEF DESCRIPTION OF THE DRAWINGS

A better understanding of the present invention will be had upon reference to the following description in conjunction with the accompanying drawings in which like numerals refer to like parts throughout the views wherein:

FIG. 1 is a perspective view of a portion of a deck made of wooden boards.

FIG. 2 is a perspective view of the deck of FIG. 1 wherein the boards have been trimmed to accept deck board caps.

FIG. 3 is a perspective view of a deck board cap and a wooden board which has been trimmed to receive a deck board cap prepared with adhesive.

FIG. 4 is a perspective view of a wooden board and deck board cap assembly.

FIG. 5 is a close-up view of a deck board cap including an extra protective exterior layer.

FIG. 6 is a circular saw including an adjustable rip-fence.

FIG. 7 is a portion of a deck which has been covered with the deck board caps of the present invention.

FIG. 8 is a perspective view of a deck board cap including barbs.

FIG. 9 is a right front perspective view of a preferred deck board trimming tool.

FIG. 10 is a left front perspective view of a preferred deck board trimming tool.

FIG. 11 is a left rear perspective view of a preferred deck board trimming tool.

FIG. 12 is a perspective view of a deck board cap attached to a trimmed deck board with screws.

FIG. 13 is a front view of a wood screw with an elastomeric gasket.

FIG. 14 is a right front side view of the preferred dual bladed deck board trimming unit.

FIG. 15 is a left front side view of the preferred dual bladed deck board trimming unit.

FIG. 16 is another right front downward perspective of the preferred dual bladed deck board trimming unit.

FIG. 17 is a rear view of the preferred dual bladed deck board trimming unit.

### DESCRIPTION OF THE PREFERRED EMBODIMENTS

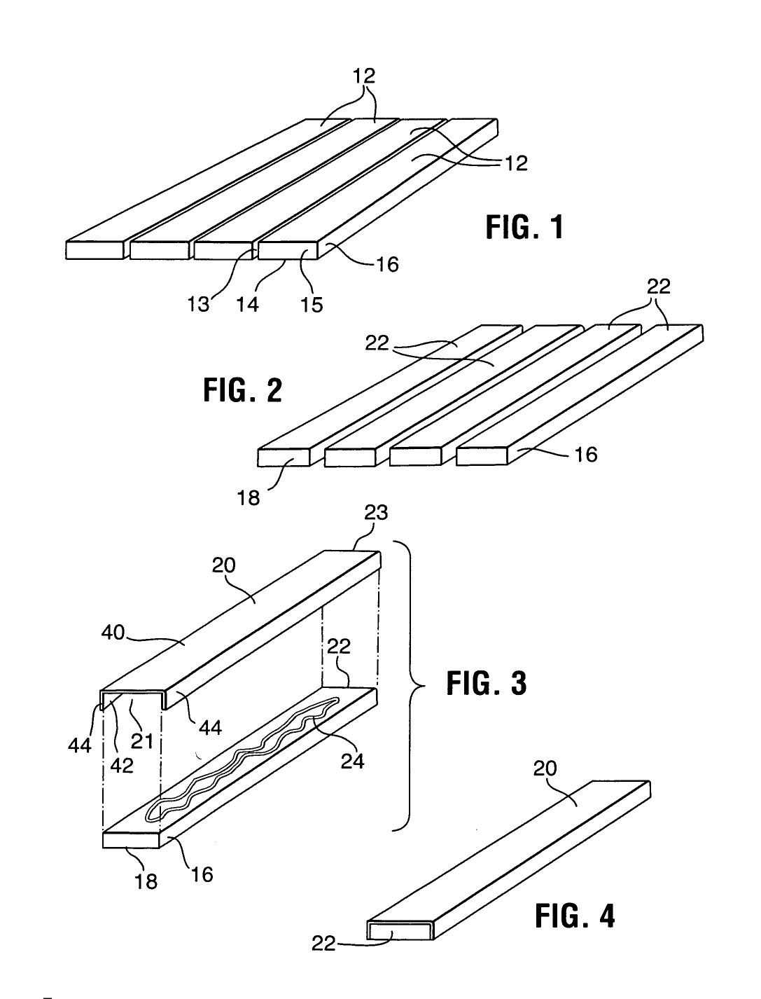

In accordance with the present invention, there is provided a system for extending the life of a treated lumber deck. FIG. 1 shows a small deck including treated boards 12. Each treated board 12 has a width 14 and a thickness 16. It is desired to cover the boards 12 with the deck board caps 20. The deck board caps 20, shown in FIG. 3, are U-shaped and include a void 21 which is intended to receive a treated board.

The deck board cap 20 preferably comprises polypropylene and is extruded or molded. Other preferred embodiments of deck board cap 20 are made of synthetics such as ABS, polystyrene or polylactide. Still other preferred embodiments are composite wood made from a mixture of wood particles, a binder and one of the following synthetics: low-density or high-density polyvinyl chloride or polypropylene, virgin or recycled thermoplastics including HDPE (high-density polyethylene), LDPE (low-density polyethylene), ABS (acrylonitrile butadiene styrene), PS (polystyrene), or PLA (polylactic acid or polylactide). Additives such as colorants, coupling agents, UV stabilizers, blowing agents, foaming agents, and lubricants are added to tailor the end product to the specific application.

The U-shaped deck board cap 20 includes a horizontal rectangular panel 40 connected to the top edges of two vertical rectangular panels 44, where the three connected panels define a void 21 which is sized to receive a trimmed wooden deck board 22. The three rectangular panels 40, 42 and 44 are all of the same selected length.

The treated boards 12 must be trimmed, or in other words, resized to receive the caps 20. A circular saw 30 with an adjustable rip fence 32 is used to remove material from the left side 13 and the right side 15 of each treated board 12 so that the final width 18 of the trimmed board 22 is equal to the width 19 of the channel 21 in the U-shaped deck board cap 20. The trimmed boards 22 now have the correct width 18 so that the deck board caps 20 just fit. Because the original treated boards 12 are fastened with nails or screws with the heads near or flush with the top surface of the boards, it is not recommended that material be removed from the top of the board 22. IF the caps are to be fastened with adhesive, it is recommended that the tops of the boards 22 are sanded to encourage better adhesion of the adhesive 24. Therefore, the depth 17 of the U-channels 20 should be equal to the thickness 16 of the treated boards 12.

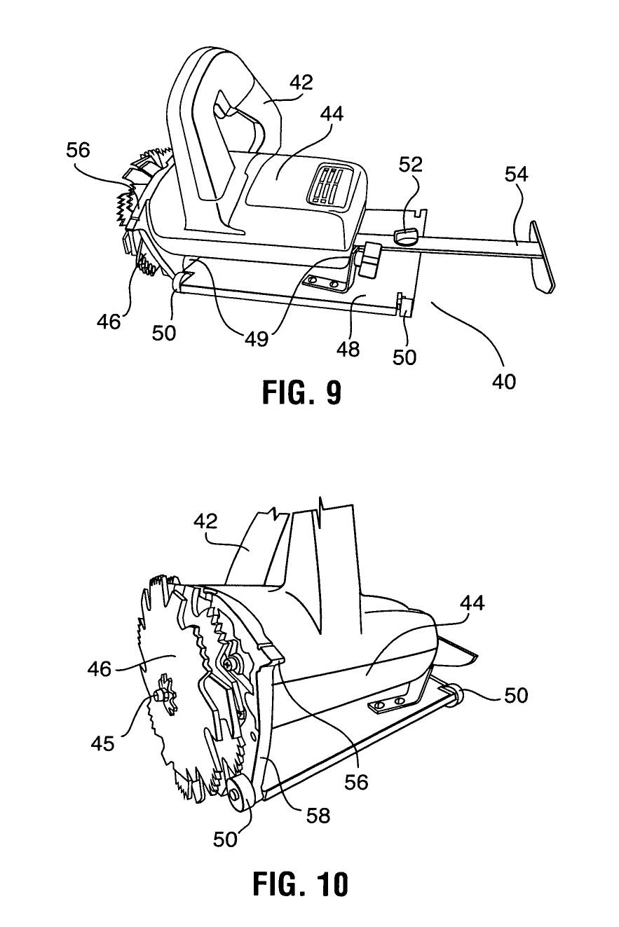

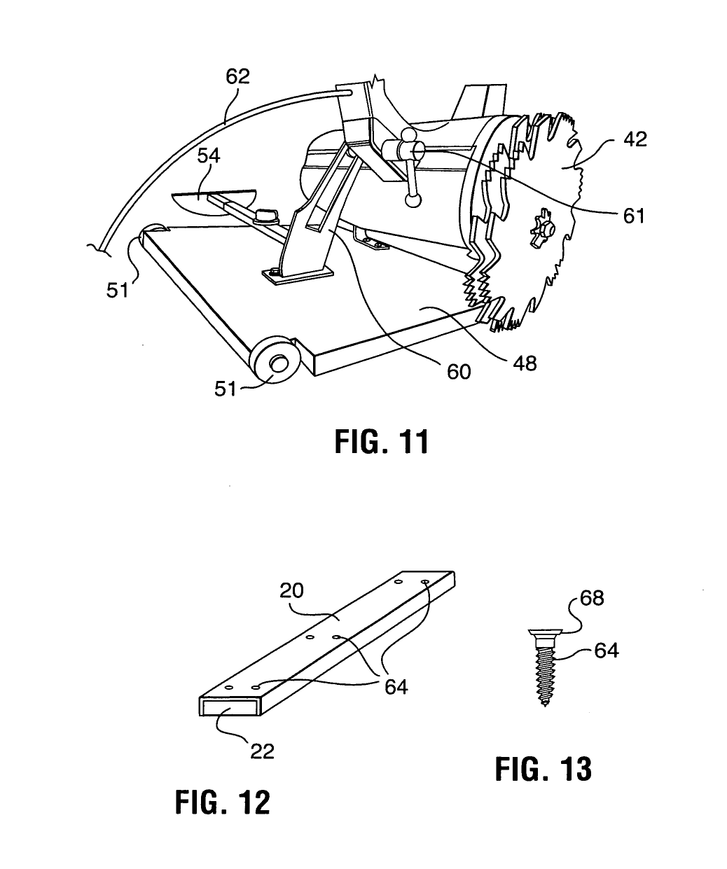

A preferred tool 40 for trimming deck boards 12 is shown in FIGS. 9-11. The resizing tool 40 includes an electric motor unit 44 with a horizontal shaft 45 extending from one end onto which is attached a circular saw blade unit 46. The motor unit 44 is rotatably attached to a planar platform 48 at pivot points 49 so that the height of the blade with respect to the bottom of the platform 48 is adjustable by sliding the locking pin 61 on the rear of the motor unit 44 up and down within the bracket 60 and then tightening the locking pin 61 to hold the motor unit in place. Blade unit 46 is a dado set. The motor unit 44 includes a forward extending lug 56 which reaches forward beyond the front edge of the blade unit 46. The lug 56 acts as a stop to prevent the rotating blades from cutting into a vertical surface such as a wall or post adjacent to the deck boards being trimmed.

There is one wheel at each corner of the platform 48. Front wheels 50 and rear wheels 51, extend below the bottom surface of the platform 48 and carry the weight of the resizing tool 40 as cutting is done. The two front wheels 50 are coaxial with one another and the two rear wheels 51 are coaxial with one another. The axis of both pairs of wheels are parallel so that the wheels 51 follow the wheels 51 as the tool is used. An adjustable fence 54 runs along the edge of a board to guide the tool 40 and guarantee the proper amount is removed from the deck board being resized. The fence is set by loosening the thumb screw 52, sliding the fence to the desired position and then re-tightening the thumb nut 52.

The preferred method of trimming the deck boards is to is accomplished by using the preferred tool trimming tool 40 and by setting the fence 54 so that an approximately equal amount of material is removed from the board at the right of the blade unit 46 and the board at the left of the blade unit 46. It is preferable that fresh wood is exposed on each side of the board. Another way of accomplishing this task is to use the tool 30 in FIG. 6 to trim both sides of each board. However, this requires one pass of the tool 30 down each side of each board. Also, the fence must be adjusted for each pass.

An alternative but less preferred method of using tool 30 involves removing material from only one side of each board. The fence on tool 30 needs to be set only once. However, this process leaves a weathered side remaining on the deck board which is allowable but not preferred.

Another alternative tool for resizing the board comprises a router having a straight bit and an adjustable fence.

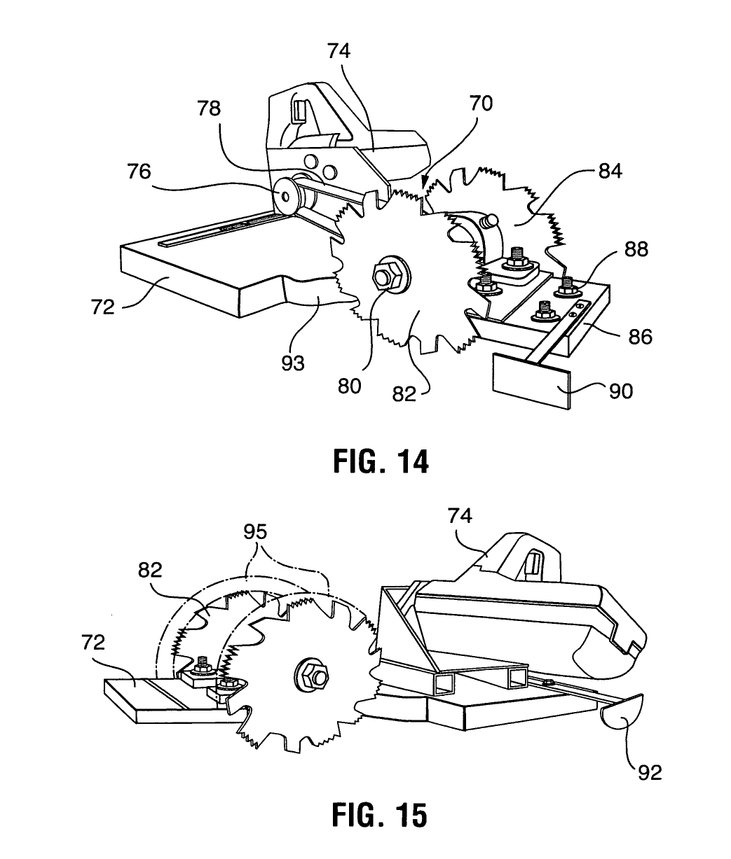

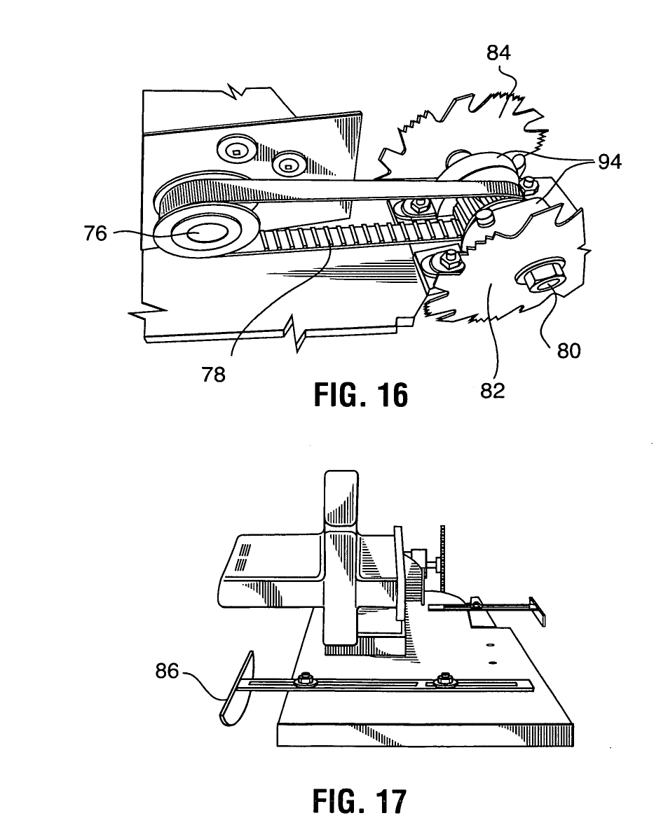

The most preferred deck board trimming unit is the dual bladed unit 70 shown in FIGS. 14-17. The dual bladed trimming unit 70 includes a sliding base 72 with a drive unit 74 which drives a belt 78 which in turn drives a blade shaft 80. The blade shaft 80 is rotatably held rigidly and adjustably in place by two saddle block bearings which are in turn held to the base 72 by bolts. Attached to the blade shaft 80 are two circular saw blades 82 and 84. The belt 78, pulley 76 and shaft 80 are preferably a toothed design to provide a more positive transfer of rotational force to the saw blades 82 and 84. Also, the saw blades 82 and 84 are preferably carbide tipped.

In the preferred embodiment, the base plate 72 includes a separately adjustable plate 86 with adjusting screws 88 to provide depth control for the blades 82 and 84. Further, the base plate 72 includes at least one guide 90 located in front of the blades which slides along the outer side of the deck board to be trimmed to ensure that the board trimming unit 70 is well controlled to provide two straight parallel edges on the trimmed deck board. Preferably, a second guide 92 near the rear end of the base 72 gives further guidance to help keep the board trimming unit 70 well controlled during trimming. It is contemplated that a third guide 93 may be used together with or instead of the guides 90, 92 to control the level of the blades. As shown in FIG. 15, blade covers or guards 95 will cover the carbide tip rotary blades. The guards may also be spring loaded to bias them against the workpiece.

It can be seen that the apart saw blades 82 and 84 are spaced apart by exactly the preferred width of a trimmed deck board ready to be capped. Two valuable advantages are realized with this design. With one pass, both sides of the deck board are trimmed and the result is a trimmed board which is the perfect width for the caps which are provided.

The preferred attachment means, shown in FIG. 12, uses countersunk screws 64 to connect the deck board caps 20 to the trimmed deck boards 22. The deck board caps 20 are pre-drilled with a countersink bit. FIG. 13 shows an elastomeric washer 68 applied to the screw 64 before screwing the screw into the pre-drilled hole and into the trimmed board 20.

Another embodiment of the invention, shown in FIG. 8 includes spaced apart teeth 34 extending downward below the edge of the cap 20. The spaced apart teeth 34 include an inward pointing barb 35 which catch under the bottom lateral edges of the trimmed deck boards 22. The deck boards 22 are typically supported by parallel floor joists on edge and which are typically one and one half inches thick and are spaced apart on either 16″ or 24″ centers. The spacing between the teeth is at least four inches and is preferably eight inches or more. Preferably, the tooth spacing should be either four or eight inches because 16 and 24 are multiples of four and eight. With a spacing of eight inches, the likelihood of a tooth 34 contacting a floor joist and preventing the complete seating of a cap 20 onto a deck board 22 is remote. In the event that the teeth 34 do contact the floor joists, however, the cap may be shortened and moved to a position where the teeth 34 do not touch the joist. When the deck board cap 20 is pressed down onto the trimmed board 22, the barbs 35 will spring outward and slip past the bottom lateral edges of the board and snap back under the board edges, thus trapping the board inside the cap 20 with the board 20 being held in place by the top surface of the barbs 35.

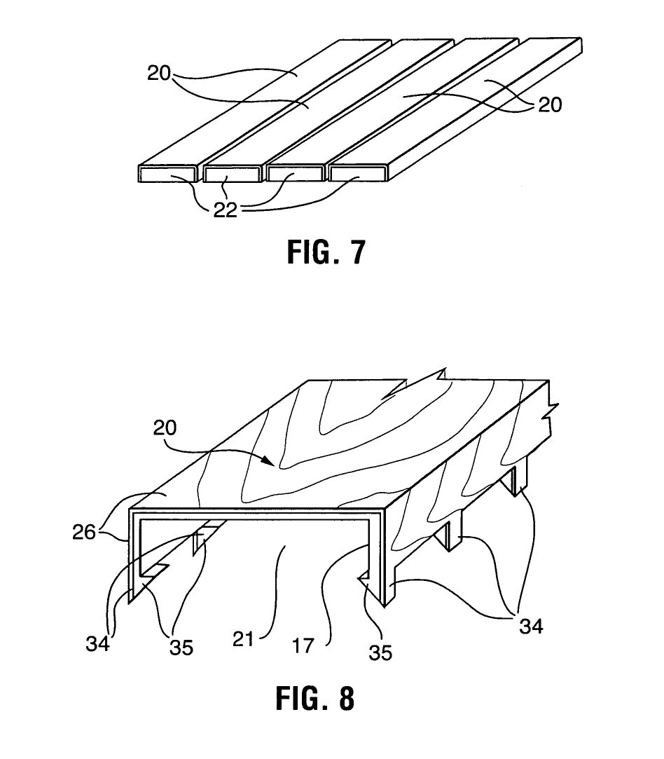

Another method of fixing the cap 20 to the deck board 22 involves using adhesive. As seen in FIG. 3, when the boards 12 have been trimmed, adhesive 24 is applied to the top of the boards 22 and the caps 20 are then applied to cover the boards and pressed down tightly into place as shown in FIGS. 4 and 7.

It is anticipated that the outer width 23 of the U-shaped caps 20 is about equal to the original width 14 of the treated boards so that the gap between the assembled deck board caps and boards is about equal to the original gaps between the deck boards 12. However, if it is desired to change the width of the gaps between the deck boards, the caps 20 may have a outer width 23 which is either greater than or less than the width 14 of the original deck boards 12.

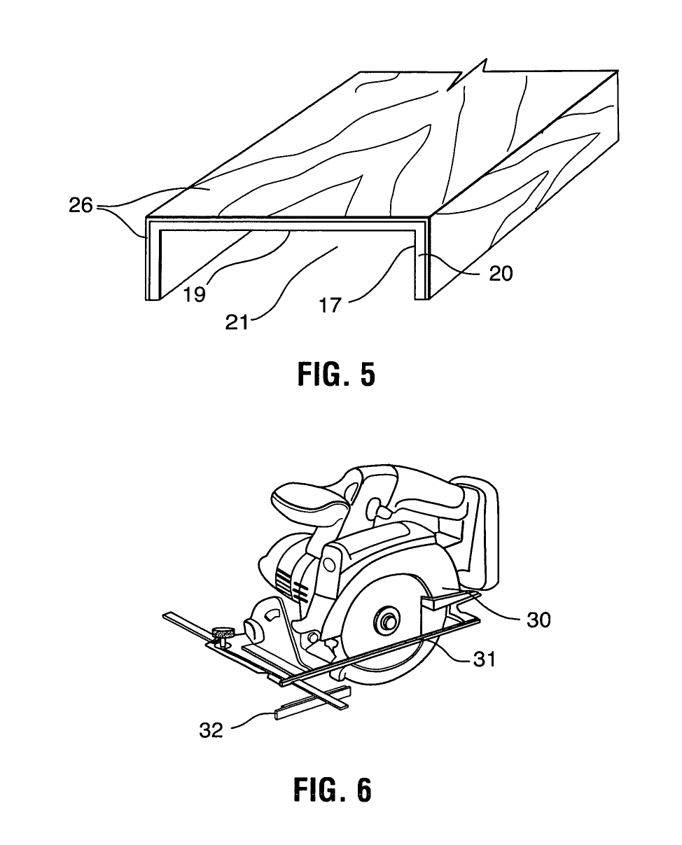

Another embodiment of the present invention, shown in FIG. 5 includes a composite deck board cap with an outer layer 26 on the top surface and outer lateral surfaces of the U-shaped deck board cap 20. The outer layer 26 is preferably a water proof, UV stabilized protective layer which may include decorative features such as a desired color and texture. The outer layer 26 is preferably 0.010 to 0.050 inches thick. The outer layer 26 is either laminated or sprayed onto the top surface and both lateral surfaces of the deck board cap 20. Another method of applying the outer layer 26 to the deck board cap is an extrusion process wherein the deck board cap 20 is extruded from a first die and the outer layer 26 is extruded onto the deck board cap by a second die in close proximity to the first die.

It is also contemplated that the cap may be used as a cover for fence rails or post. Moreover, the leading side edges may be extended to cover the side edges of the fence rail or post. A back cover may have side edges extending downward therefrom for cooperative engagement with the side edges of the top cover, or the bottom of the top side edges may include an offset or detent to allow a friction fit, snap-fit, tongue and groove arrangement, or other cooperative engagement with the side edges of a back plate so that the wood rail or post is completely covered with the cap material.

A method of renewing and protecting a board deck including the steps of providing a board deck structure, a board trimming tool, deck board caps with pre-drilled spaced apart countersunk holes formed therein, a screw driver and countersunk wood screws; selecting a first board within said board deck structure; trimming a first amount of material from a first side of said selected board; trimming a second amount of material from a second side of said selected board, said trimming of said first and said second amounts of material causing said selected board to have a width equal to said rectangular void between said two vertical panels of a deck board cap; pressing a selected deck board cap over said selected board so that said selected board is between said two vertical panels and said cap is pressed tightly against a top surface of said selected board at a selected horizontal position on said selected board; inserting and driving said countersunk wood screws into said pre-drilled countersunk spaced apart holes of said selected board cap and into said selected board; and selecting a next selected board within said board deck structure and performing the four preceding steps with respect to said next selected board until all boards of said board deck structure are capped.

The foregoing detailed description is given primarily for clearness of understanding and no unnecessary limitations are to be understood therefrom, for modification will become obvious to those skilled in the art upon reading this disclosure and may be made upon departing from the spirit of the invention and scope of the appended claims. Accordingly, this invention is not intended to be limited by the specific exemplification presented herein above. Rather, what is intended to be covered is within the spirit and scope of the appended claims.

I claim:

1. A deck board cap, for covering and protecting deck boards, comprising:
a U-shaped deck board cap made from synthetic materials, said U-shaped deck board cap comprising two vertical lateral panels connected at their top edges to a horizontal panel, said U-shaped deck board cap having a rectangular void formed therein between said two lateral panels, said rectangular void sized to receive a wooden deck board trimmed to a selected width, said two lateral panels and said horizontal panel having a selected length.

2. The deck board cap of claim 1 wherein said synthetic materials comprises polypropylene.

3. The deck board cap of claim 1 wherein said synthetic materials are selected from the group consisting of low-density polyvinyl chloride, high-density polyvinyl chloride, virgin high-density polypropylene, virgin low-density polypropylene, recycled high-density polypropylene, recycled low-density polypropylene, acrylonitrile butadiene styrene, polystyrene and polylactide.

4. The deck board cap of claim 1 wherein said deck board cap is made from a process selected from the group consisting of extrusion and injection molding.

5. A deck board trimming unit including a base member with a rotary drive unit which drives a belt which in turn drives a blade shaft, said blade shaft rotatably held rigidly and adjustably in place by two saddle block bearings which are in turn held to the base by bolts, said blade shaft having two spaced apart parallel circular saw blades, said base member having a separately adjustable bottom plate with adjusting screws to provide depth control for said blades, said base plate having at least one guide located in front of the blades which slides along the outer side of a deck board to be trimmed.

6. A deck board cap, for covering and protecting deck boards, consisting of:
a U-shaped deck board cap made from synthetic materials, said U-shaped deck board cap comprising two vertical lateral panels connected at their top edges to a horizontal panel, said U-shaped deck board cap having a rectangular void formed therein between said two lateral panels, said rectangular void sized to receive a wooden deck board trimmed to a selected width, said two lateral panels and said horizontal panel having a selected length.
